(19) United States
(12) Patent Application Publication
(10) Pub. No.: US 2026/0196523 A1
(43) Pub. Date: Jul. 9, 2026

(54) ANODE SLURRY, ANODE FOR LITHIUM SECONDARY BATTERY, AND LITHIUM SECONDARY BATTERY COMPRISING SAME

(71) Applicant: SK ON CO., LTD., Seoul (KR)

(72) Inventors: Kwang Ho JEONG, Daejeon (KR); Young Gil CHOI, Daejeon (KR)

(21) Appl. No.: 19/558,458

(22) Filed: Mar. 6, 2026

Related U.S. Application Data
(63) Continuation of application No. PCT/KR2024/013029, filed on Aug. 30, 2024.

(30) Foreign Application Priority Data
Sep. 6, 2023 (KR) 10-2023-0118340

(51) Int. Cl. H01M 4/62; C09D 5/24; C09D 7/61; C09D 7/63; C09D 109/06; C09D 133/02; C09D 133/26; H01M 4/02; H01M 4/134; H01M 4/48; H01M 10/052

(52) U.S. Cl. CPC H01M 4/628; C09D 5/24; C09D 7/61; C09D 7/63; C09D 109/06; C09D 133/02; C09D 133/26; H01M 4/134; H01M 4/48; H01M 4/622; H01M 10/052; H01M 2004/027

(57) ABSTRACT

According to embodiments of the present disclosure, an aqueous anode slurry may include an anode active material, a binder, and an organic acid compound having at least two oxygen-containing functional groups. In a molecular structure of the organic acid compound, a bond angle between oxygen-containing functional groups is 90° or more, and the content of the organic acid compound may be greater than 0.01 wt % and less than 0.1 wt %, based on the total solid weight of the aqueous anode slurry.

### CROSS-REFERENCE TO RELATED APPLICATION AND CLAIM OF PRIORITY

This patent application is a Bypass Continuation Application of PCT/KR2024/013029 filed on Aug. 30, 2024, which claims priority to Korean patent application no. 10-2023-0118340 filed on Sep. 6, 2023, the entire disclosure of which is incorporated herein by reference.

### TECHNICAL FIELD

The present disclosure relates to an anode slurry, an anode for a lithium secondary battery, and a lithium secondary battery including the anode for a lithium secondary battery.

### BACKGROUND ART

Secondary batteries are batteries that can be repeatedly charged and discharged. With the development of information and communication and display industries, they have been widely applied as power sources for portable electronic communication devices, such as camcorders, mobile phones, and laptop PCs. In addition, battery packs including secondary batteries have recently been developed and applied as power sources for eco-friendly vehicles, such as hybrid vehicles.

Examples of secondary batteries may include a lithium secondary battery, a nickel-cadmium battery, and a nickel-hydrogen battery. Among these, the lithium secondary battery has a high operating voltage and a high energy density per unit weight, and is advantageous in terms of increased charging speed and weight reduction.

The lithium secondary battery may include an electrode assembly including a cathode, an anode, and a separation membrane (separator). For example, the cathode and the anode may be formed by coating a composition for forming an electrode on an electrode current collector such as a metal foil. The composition for forming an electrode may be prepared by mixing an electrode active material, a binder, and a solvent, and may have, for example, a slurry form.

Recently, as the application scope of lithium secondary batteries continues to expand, high capacity and high output characteristics have been required. In addition, the lithium secondary battery needs to operate stably even under harsh conditions depending on the usage environment. Therefore, cycle characteristics and stability, together with high capacity and high output, should be considered.

### SUMMARY OF INVENTION

### Problems to be Solved by Invention

An object of the present disclosure is to provide an anode slurry having improved electrochemical characteristics and stability.

Another object of the present disclosure is to provide an anode for a lithium secondary battery having improved electrochemical characteristics and stability.

Yet another object of the present disclosure is to provide a lithium secondary battery having improved electrochemical characteristics and stability.

### Means for Solving Problems

An aqueous anode slurry according to embodiments of the present disclosure may include: an anode active material; a binder; and an organic acid compound having at least two oxygen-containing functional groups. In a molecular structure of the organic acid compound, a bond angle between the oxygen-containing functional groups may be 90° or more. The content of the organic acid compound may be greater than 0.01% by weight and less than 0.1% by weight, based on the total solid weight of the aqueous anode slurry.

In some embodiments, the binder may include carboxymethyl cellulose, sodium carboxymethyl cellulose, lithium carboxymethyl cellulose, polyvinyl alcohol, polyacrylic acid, polyacrylamide, or a copolymer of two or more thereof.

In some embodiments, the binder may include polyvinyl alcohol, polyacrylic acid, polyacrylamide, or a copolymer of two or more thereof.

In some embodiments, the anode active material may include a silicon-containing material.

In some embodiments, the oxygen-containing functional group may include an aldehyde group, a carboxyl group, or a hydroxyl group bonded to a carbon atom that does not form a π bond with an oxygen atom.

In some embodiments, in the molecular structure of the organic acid compound, the bond angle between the oxygen-containing functional groups may be an internal angle between bond lines connecting the oxygen-containing functional groups and carbon atoms bonded thereto.

In some embodiments, the organic acid compound may include at least one acid compound selected from the group consisting of lactic acid, glycolic acid, succinic acid, fumaric acid, malonic acid, glutaric acid, adipic acid, pimelic acid, and oxalic acid.

In one embodiment, the organic acid compound may include at least one acid compound selected from the group consisting of lactic acid, fumaric acid, succinic acid, and oxalic acid.

In some embodiments, the organic acid compound may have two or three oxygen-containing functional groups.

In some embodiments, the content of the organic acid compound may be 0.02% by weight to 0.08% by weight, based on the total solid weight of the aqueous anode slurry.

In some embodiments, the aqueous anode slurry may further include an aqueous solvent.

In some embodiments, a pH of the aqueous anode slurry may be 8 or less.

An anode for a lithium secondary battery according to embodiments of the present disclosure may include an anode active material layer including an anode active material, a binder, and an organic acid compound having at least two oxygen-containing functional groups. In a molecular structure of the organic acid compound, a bond angle between the oxygen-containing functional groups may be 90° or more, and the content of the organic acid compound may be greater than 0.01% by weight and less than 0.1% by weight, based on the total weight of the anode active material layer.

In some embodiments, the organic acid compound may be crosslinked with the binder.

In some embodiments, the anode for a lithium secondary battery may further include an anode current collector, wherein the anode active material layer may be disposed on at least one surface of the anode current collector.

In one embodiment, an adhesion between the anode active material layer and the anode current collector may be 0.5 N/18 mm or more.

A lithium secondary battery according to embodiments of the present disclosure may include the anode for a lithium secondary battery according to the above-described embodiments, and a cathode disposed opposite the anode for a lithium secondary battery.

### Advantageous Effects

The aqueous anode slurry according to embodiments of the present disclosure may include at least two oxygen-containing functional groups, and an organic acid compound having a specific molecular structure. The aqueous anode slurry may have improved coating properties, and the ionic conductivity thereof may be enhanced.

The anode for a lithium secondary battery may include the above-described organic acid compound. The content of the organic acid compound in the aqueous anode slurry or the anode for a lithium secondary battery may be adjusted within a predetermined range. The anode for a lithium secondary battery may have low resistance without reducing energy density, and the high-temperature stability thereof may be improved.

The lithium secondary battery may include the anode for a lithium secondary battery. The internal resistance of the lithium secondary battery may be reduced, and the capacity, cycle life characteristics, and stability may be improved.

### BRIEF DESCRIPTION OF DRAWINGS

FIGS. 1 and 2 are a schematic plan view and a schematic cross-sectional view, respectively, illustrating a lithium secondary battery according to exemplary embodiments.

### MODE FOR CARRYING OUT INVENTION

According to embodiments of the present disclosure, an aqueous anode slurry may include an anode active material, a binder, and an organic acid compound.

According to embodiments of the present disclosure, an anode for a lithium secondary battery may include an anode active material, a binder, and an organic acid compound. According to embodiments of the present disclosure, a lithium secondary battery may include the above-described anode for a lithium secondary battery.

The lithium secondary battery according to embodiments of the present disclosure may be widely applied in green technology fields, such as electric vehicles, battery charging stations, as well as solar power generation, wind power generation, and the like, which use batteries. In addition, the lithium secondary battery according to embodiments of the present disclosure may be used in eco-friendly electric vehicles, hybrid vehicles, and the like, which are aimed at mitigating climate change by reducing air pollution and greenhouse gas emissions.

The terms “upper surface,” “lower surface,” and the like used herein indicate the relative positions of respective components and do not imply absolute positional relationships.

Hereinafter, exemplary embodiments of the present disclosure will be described in detail. However, these embodiments are merely illustrative, and the present disclosure is not limited to the specific embodiments described as examples.

The anode slurry according to exemplary embodiments may include an anode active material, a binder, and an organic acid compound.

In one embodiment, the anode slurry may further include a solvent. An aqueous solvent may be used as the solvent. For example, the anode slurry may be an aqueous composition.

In one embodiment, the aqueous solvent may include water, distilled water, pure water, ultrapure water or the like.

According to exemplary embodiments, the organic acid compound may include at least two oxygen-containing functional groups. The oxygen-containing functional groups may refer to terminal functional groups containing oxygen atoms.

For example, the oxygen-containing functional group may include a hydroxyl group (OH), a carboxyl group (COOH), an aldehyde group (CHO), and/or a carbonyl group (C═O).

The hydroxyl group of the oxygen-containing functional group may be bonded to a carbon atom that does not form a π bond with an oxygen atom. The carbonyl group of the oxygen-containing functional group may not be bonded to an —OH group or a hydrogen atom.

The organic acid compound may include a plurality of oxygen-containing functional groups that facilitate the migration of lithium ions between anode active materials. For example, through the oxygen-containing functional groups, a shortened migration path and an increased migration speed of lithium ions may be achieved, thereby improving the ionic conductivity of the anode for a lithium secondary battery. Accordingly, the internal resistance of the lithium secondary battery may be reduced, thereby improving output characteristics.

In some embodiments, the organic acid compound may form crosslinking bonds with the binder within the anode through the oxygen-containing functional groups. For example, during the drying process of the anode slurry, a chemical bond may be formed between the oxygen-containing functional group of the organic acid compound and the binder.

In one embodiment, a condensation reaction may occur between the organic acid compound and the binder during the drying of the anode slurry. For example, the hydroxyl group or carboxyl group of the oxygen-containing functional groups may form a covalent bond with the carboxyl group or hydroxyl group contained in the binder through a dehydration reaction. Accordingly, a crosslinked network may be formed in which organic acid compound units and binder units are bonded to each other via oxygen atoms.

The crosslinked network may be formed between the binder and the organic acid compound, thereby further improving the structural and mechanical stability of the anode and further enhancing the adhesion between the anode active material layer and the anode current collector. Consequently, volume expansion and swelling of the anode due to repeated charge and discharge cycles may be suppressed, and detachment and delamination of the anode active material layer may be prevented.

According to exemplary embodiments, in a molecular structure of the organic acid compound, a bond angle between the oxygen-containing functional groups may be 90° or more. The molecular structure of the organic acid compound may refer to a planar structural formula of the organic acid compound. For example, the bond angle between the oxygen-containing functional groups may be calculated based on the Lewis structure or a skeletal formula of the organic acid compound.

The bond angle between the oxygen-containing functional groups may refer to an internal angle formed by bond lines of each of the oxygen-containing functional groups. For example, in the molecular structure of the organic acid compound, the internal angle between the bond lines may be 90° or more, or 100° or more. When the bond lines are parallel to each other, the internal angle between the bond lines is 180°.

The bond line of the oxygen-containing functional group may refer to a straight line connecting the oxygen-containing functional group and a carbon atom bonded thereto in the molecular structure (e.g., the Lewis structure or the skeletal formula) of the organic acid compound.

For example, in the compounds represented by Formulae 1 to 4 below, the internal angle between the bond lines of the oxygen-containing functional groups is 90° or more.

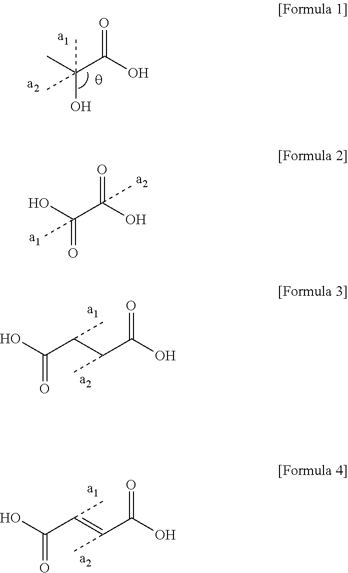

In Formula 1, a bond line a₁ of the hydroxyl group is a straight line connecting the hydroxyl group (—OH) and the carbon atom bonded thereto. A bond line a₂ of the carboxyl group is a straight line connecting the carboxyl group (—COOH) and the carbon atom bonded thereto. In Formula 1, an internal angle θ between the bond lines of the oxygen-containing functional groups is approximately 109.5°.

In Formula 2, the internal angle between bond lines a₁ and a₂ of the carboxyl group is approximately 180°.

In Formulae 3 and 4, the bond lines a₁ and a₂ of the carboxyl group are parallel to each other, and the internal angle formed by the bond lines is approximately 180°.

In one example, in the compounds represented by Formulae 5 to 7 below, the internal angle between the bond lines of the oxygen-containing functional groups is less than 90°.

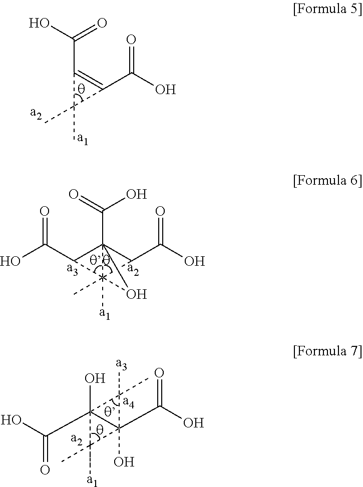

In Formula 5, an internal angle θ between the bond lines a₁ and a₂ of the carboxyl group is approximately 43.2°. In Formula 6, the internal angle θ between the bond lines a₁ and a₂ of the carboxyl group, and an internal angle θ′ between bond lines a₂ and a₃, are each approximately 43.2°. In Formula 7, an internal angle θ between the bond line a₁ of the hydroxyl group and the bond line a₂ of the carboxyl group, and an internal angle θ′ between a bond line a₃ of the hydroxyl group and a bond line a₄ of the carboxyl group, are each approximately 43.2°.

According to exemplary embodiments, since all the internal angles formed by the bond lines of the oxygen-containing functional groups included in the organic acid compound are 90° or more, lithium ion conductivity may be further improved, and cycle life characteristics and stability may be further enhanced.

For example, if the internal angle between the bond lines of the oxygen-containing functional groups is less than 90°, steric hindrance may interfere with the formation of crosslinking bonds between the oxygen-containing functional groups of the organic acid compound and the binder. In addition, migration of lithium ions may be hindered by the oxygen-containing functional groups, thereby deteriorating the output and cycle life characteristics of the lithium secondary battery.

In some embodiments, the organic acid compound may include at least one acid compound selected from the group consisting of lactic acid, glycolic acid, succinic acid, fumaric acid, malonic acid, glutaric acid, adipic acid, pimelic acid, and oxalic acid. These may be used alone or in combination of two or more thereof.

In one embodiment, the organic acid compound may have two or three oxygen-containing functional groups. Within this range, an increase in pH of the anode slurry due to a high concentration of oxygen-containing functional groups may be suppressed, and interaction between the binder and the organic acid compound, as well as lithium ion conductivity, may be further enhanced.

According to exemplary embodiments, the content of the organic acid compound may be greater than 0.01% by weight (“wt %”) and less than 0.1 wt %, based on the total solid weight of the aqueous anode slurry. Within this range, the viscosity and pH of the anode slurry may be adjusted within an appropriate range, thereby improving the coating properties of the anode slurry and enhancing the high-temperature stability and cycle life characteristics of the anode.

In one embodiment, the total solid content of the anode slurry refers to the total weight of components excluding a solvent in the anode slurry. For example, the total solid content may refer to the combined weight of an anode active material, a binder, and an organic acid compound. When the anode slurry further includes a conductive material, the total solid content may refer to the combined weight of the anode active material, the binder, the organic acid compound, and the conductive material.

For example, if the content of the organic acid compound is 0.01 wt % or less, the oxygen-containing functional groups are present at a low concentration, thereby hindering smooth migration of lithium ions and resulting in insufficient crosslinking points between the binder and the organic acid compound.

For example, if the content of the organic acid compound is 0.1 wt % or more, the adhesion between the anode current collector and the anode active material layer may be decreased due to an excessive amount of organic acid compound, thereby deteriorating the high-temperature stability and cycle life characteristics.

In one embodiment, the content of the organic acid compound may be 0.02 wt % to 0.08 wt %, or 0.04 wt % to 0.08 wt %, based on the total solid weight of the aqueous anode slurry. Within this range, cycle life characteristics, high-temperature stability, and electrode adhesion may be further improved.

According to exemplary embodiments, the binder may include a water-soluble thickening binder. The water-soluble thickening binder may include carboxymethyl cellulose (CMC), sodium carboxymethyl cellulose, lithium carboxymethyl cellulose, polyvinyl alcohol (PVA), polyacrylic acid (PAA), polyacrylamide (PAM), or a copolymer of two or more thereof.

In one embodiment, the copolymer may include a copolymer of at least two selected from polyvinyl alcohol, polyacrylic acid, and polyacrylamide. For example, the copolymer may include a copolymer of polyvinyl alcohol and polyacrylic acid (PVA-PAA copolymer) and/or a copolymer of polyacrylamide and polyacrylic acid (PAM-PAA copolymer).

When the above-described polymer compound is included as the binder, the dispersibility of the aqueous anode slurry may be improved, and the coating properties of the anode slurry may be further enhanced. In addition, the above-described polymer compound has high affinity and compatibility with the organic acid compound, thereby allowing the formation of a denser crosslinked network. Therefore, the binding strength of the binder may be further improved, and the adhesion of the anode active material layer may be further enhanced.

In some embodiments, the binder may further include an aqueous binder. The aqueous binder may include styrene-butadiene rubber (SBR), acrylonitrile butadiene rubber (NBR), hydrogenated nitrile butadiene rubber (HNBR), acrylic rubber, hydroxyethyl cellulose, an acrylate polymer or the like.

In some embodiments, the content of the thickening binder may be 20 wt % or more, 30 wt % or more, 50 wt % or more, or 70 wt % or more, based on the total weight of the binder. In one embodiment, the content of the thickening binder may be 95 wt % or less, 90 wt % or less, or 80 wt % or less, based on the total weight of the binder.

Within the above range, the binder may be more uniformly dispersed in the anode slurry and may form a crosslinked network with the organic acid compound, thereby further enhancing the binding strength. Therefore, the internal resistance of the anode may be reduced, and cycle life characteristics, thermal stability, and mechanical stability may be further improved.

In some embodiments, the content of the binder may be 0.5 wt % to 20 wt %, 1 wt % to 10 wt %, 2 wt % to 5 wt %, or 1 wt % to 4 wt %, based on the total solid weight of the anode slurry. Within this range, the internal resistance of the anode may be reduced, while the adhesion and structural stability of the anode active material layer may be improved.

In some embodiments, the anode active material may include a silicon-containing material, a carbon-based active material, or a mixture thereof.

In some embodiments, the silicon-containing material may include silicon (Si), silicon oxide (SiOₓ, 0<x<2), a silicon-metal alloy, or a silicon-carbon composite (Si—C). These may be included alone or in combination of two or more thereof.

In one embodiment, the SiOₓ may include a lithium compound or a magnesium compound. For example, the SiOₓ may be pretreated with lithium or magnesium to include lithium silicate or magnesium silicate in the interior and/or on the surface of particles. The lithium silicate may include Li₂SiO₃, Li₂Si₂O₅, Li₄SiO₄, Li₄Si₃O₈ or the like.

In some embodiments, the silicon-carbon composite may include silicon carbide (SiC) or silicon-carbon particles having a core-shell structure.

In some embodiments, the carbon-based active material may include crystalline carbon or amorphous carbon.

In one embodiment, the amorphous carbon may include hard carbon, soft carbon, coke, mesocarbon microbead (MCMB), mesophase pitch-based carbon fiber (MPCF) or the like.

In one embodiment, the crystalline carbon may include graphite-based carbon such as artificial graphite, natural graphite, graphitized coke, graphitized MCMB, graphitized MPCF or the like.

In one embodiment, the anode active material may include a silicon-containing material. The silicon-containing material may have a high energy density, thereby increasing the capacity of the lithium secondary battery. In addition, expansion of the anode due to the silicon-containing material may be suppressed by the organic acid compound, and lithium ion conductivity may be supplemented, thereby improving the output and cycle life characteristics of the lithium secondary battery.

In one embodiment, the anode active material may include a lithium alloy, silicon, tin or the like. The lithium alloy may include lithium and aluminum, zinc, bismuth, cadmium, antimony, silicon, lead, tin, gallium, indium or the like.

In some embodiments, the content of the anode active material may be 75 wt % to 99 wt %, 85 wt % to 98 wt %, or 95 wt % to 98 wt %, based on the total solid weight of the anode slurry. Within this range, the energy density of the anode may be enhanced, and the output and capacity of the lithium secondary battery may be further improved.

In some embodiments, the anode slurry may further include a conductive material. The conductive material may promote electron migration. For example, the conductive material may include carbon-based conductive materials such as graphite, carbon black, graphene, or carbon nanotubes; and/or metal-based conductive materials such as tin, tin oxide, and titanium oxide; as well as perovskite materials such as LaSrCoO₃, and LaSrMnO₃.

In one embodiment, the content of the conductive material may be 0.5 wt % to 5 wt %, or 1 wt % to 3 wt %, based on the total solid weight of the anode slurry.

In some embodiments, the pH of the anode slurry may be 8 or less. Accordingly, the viscosity of the anode slurry may be adjusted within an appropriate range, dispersibility may be improved, and the generation of byproducts such as hydrogen gas may be suppressed, thereby enhancing the processability and stability of the anode slurry.

In one embodiment, the pH of the anode slurry may be 6 to 8. Within this range, side reactions of the anode active material and the generation of hydrogen gas may be suppressed, thereby improving the output, capacity, and cycle life characteristics of the lithium secondary battery.

In one embodiment, the pH of the anode slurry may be measured using a pH meter. The CAS Benchtop pH tester PM-3 may be used as the pH meter.

An anode for a lithium secondary battery according to embodiments of the present disclosure (hereinafter, also abbreviated as an anode) may be prepared using the above-described anode slurry.

For example, the anode may include an anode current collector and an anode active material layer formed on at least one surface of the anode current collector. The anode active material layer may be formed on both surfaces (e.g., upper and lower surfaces) of the anode current collector.

The anode active material layer may be formed by applying the above-described anode slurry onto at least one surface of the anode current collector, followed by drying and/or roll-pressing. For example, the anode active material layer may include an anode active material, a binder, and the organic acid compound.

The anode current collector may include gold, stainless steel, nickel, aluminum, titanium, copper, or an alloy thereof. For example, the anode current collector may include copper or a copper alloy.

According to exemplary embodiments, the content of the organic acid compound may be greater than 0.01 wt % and less than 0.1 wt %, 0.02 wt % to 0.08 wt %, or 0.04 wt % to 0.08 wt %, based on the total weight of the anode active material layer.

In some embodiments, the content of the anode active material may be 75 wt % to 99 wt %, 85 wt % to 98 wt %, or 95 wt % to 98 wt %, based on the total weight of the anode active material layer.

In some embodiments, the content of the binder may be 0.5 wt % to 20 wt %, 1 wt % to 10 wt %, 2 wt % to 5 wt %, or 1 wt % to 4 wt %, based on the total weight of the anode active material layer.

In one embodiment, the anode active material layer may further include a conductive material. In one embodiment, the content of the conductive material may be 0.5 wt % to 5 wt %, or 1 wt % to 3 wt %, based on the total weight of the anode active material layer.

In some embodiments, the binder and the organic acid compound within the anode active material layer may be crosslinked with each other. For example, the oxygen-containing functional groups of the organic acid compound may act as crosslinking sites for the binder, thereby linking binder components to each other. Accordingly, a dense crosslinked network may be formed within the anode active material layer, thereby improving the structural and mechanical stability of the anode active material layer and increasing the adhesion between the anode active material layer and the anode current collector.

In some embodiments, the adhesion between the anode active material layer and the anode current collector may be 0.5 N/18 mm or more. The anode active material layer may have high adhesion to the anode current collector, thereby preventing volume expansion of the anode and detachment and delamination of the anode active material layer. In addition, electron migration between the anode current collector and the anode active material layer may be further promoted, thereby reducing the internal resistance of the anode.

In one embodiment, the adhesion between the anode active material layer and the anode current collector may be measured using an adhesion measuring device for an electrode substrate. Examples of such an adhesion measuring device may include the DS2-50N manufactured by IMADA.

In one embodiment, the adhesion between the anode active material layer and the anode current collector may be 0.5 N/18 mm to 0.6 N/18 mm, or 0.51 N/18 mm to 0.58 N/18 mm.

The lithium secondary battery according to embodiments of the present disclosure may include the above-described anode and a cathode disposed opposite the anode.

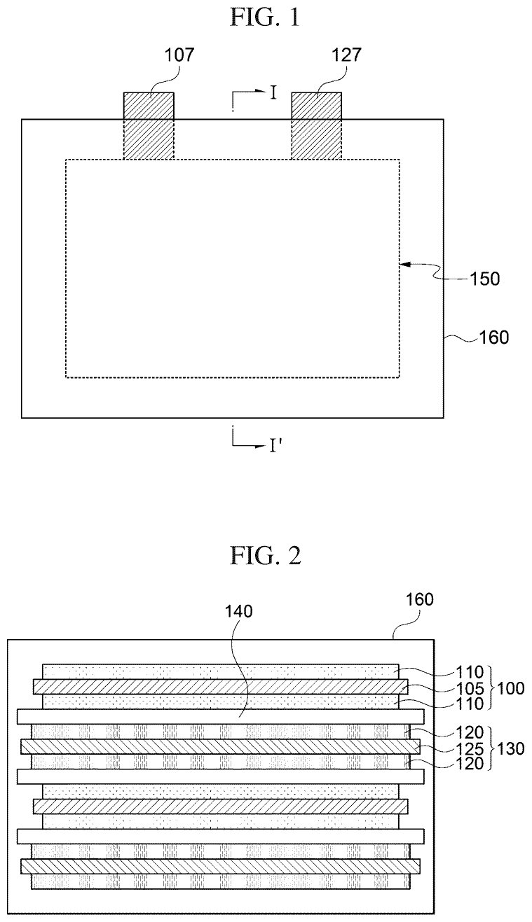

FIGS. 1 and 2 are a schematic plan view and a schematic cross-sectional view, respectively, illustrating the lithium secondary battery according to exemplary embodiments.

Referring to FIGS. 1 and 2, the lithium secondary battery may include a cathode 100 and an anode 130 disposed opposite the cathode 100.

The anode 130 may include an anode current collector 125 and an anode active material layer 120 formed on at least one surface of the anode current collector 125.

The cathode 100 may include a cathode current collector 105 and a cathode active material layer 110 formed by coating a cathode active material on at least one surface of the cathode current collector 105.

For example, a cathode slurry may be prepared by mixing and stirring a cathode active material with a cathode conductive material and/or a cathode binder in a solvent. The cathode slurry may be applied onto the cathode current collector 105, and then dried and roll-pressed to form the cathode 100.

The cathode current collector 105 may include stainless steel, nickel, aluminum, titanium, or an alloy thereof. The cathode current collector 105 may also include aluminum or stainless steel having a surface treated with carbon, nickel, titanium or silver.

Examples of the cathode active material include one or more compounds selected from a lithium iron phosphate compound, a lithium cobalt oxide, a lithium manganese oxide, a lithium nickel oxide, or a lithium composite oxide. For example, the cathode active material may include a layered compound such as lithium cobalt oxide (LiCoO₂) or lithium nickel oxide (LiNiO₂), or a lithium manganese oxide such as LiMnO₃, LiMn₂O₃, and LiMnO₂; a lithium copper oxide (Li₂CuO₂); a vanadium oxide such as LiV₃O₈, LiFe₃O₄, V₂O₅, and Cu₂ VO₇; or a lithium iron phosphate oxide such as LiFePO₄.

In one embodiment, the cathode active material may include a compound represented by Formula 8.

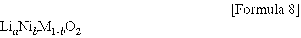

In Formula 8, a and b may satisfy 0.95≤a≤1.10, and b>0.5, and M may be at least one element selected from the group consisting of Na, Mg, Ca, Y, Ti, Zr, Hf, V, Nb, Ta, Cr, Mo, W, Mn, Co, Fe, Cu, Ag, Zn, B, Al, Ga, C, Si, Sn, Ba and Sr.

In one embodiment, the lithium transition metal oxide includes nickel (Ni) and may further include at least one of cobalt (Co) or manganese (Mn). For example, the lithium transition metal oxide may include a nickel-cobalt-manganese (NCM)-based lithium oxide.

For example, nickel (Ni) may be provided as a metal associated with the capacity of the lithium secondary battery. The higher the content of nickel, the greater the improvement in capacity and output of the lithium secondary battery. However, if the content of nickel increases excessively, the cycle life of the lithium secondary battery may be reduced, and it may be disadvantageous in terms of mechanical and electrical stability.

In one embodiment, cobalt (Co) may improve the conductivity or resistance of the lithium secondary battery. In one embodiment, manganese (Mn) may improve the mechanical and electrical stability of the lithium secondary battery.

The chemical structure represented by Formula 8 indicates a bonding relationship among elements included in a lattice structure or a crystal structure of the lithium transition metal oxide and does not exclude the presence of additional elements. For example, M may serve as a main active element of the lithium transition metal oxide. Formula 8 is provided to represent the bonding relationship among the main active elements and should be understood as encompassing the introduction or substitution of additional elements.

In one embodiment, auxiliary elements may be further included in addition to the main active element to enhance chemical stability of the crystal structure. The auxiliary elements may be incorporated into the crystal structure to form bonds, and such a case should also be understood as falling within the chemical structure range represented by Formula 8.

The cathode binder may include vinylidene fluoride-hexafluoropropylene copolymer (PVDF-co-HFP), polyvinylidene fluoride (PVDF), polyacrylonitrile, polymethyl methacrylate, nitrile butadiene rubber and the like.

The cathode conductive material may include carbon-based conductive materials such as graphite, carbon black, graphene, or carbon nanotubes; and/or metal-based conductive materials such as tin, tin oxide, and titanium oxide; as well as perovskite materials such as LaSrCoO₃, and LaSrMnO₃.

In some embodiments, a separator 140 may be interposed between the cathode 100 and the anode 130. The separator 140 may include a porous polymer film made of a polyolefin polymer such as ethylene homopolymer, propylene homopolymer, ethylene/butene copolymer, ethylene/hexene copolymer, or ethylene/methacrylate copolymer. The separator 140 may include a nonwoven fabric made of glass fibers having a high melting point, polyethylene terephthalate fibers, etc.

According to exemplary embodiments, an electrode cell may be defined by the cathode 100, the anode 130, and the separator 140, and a plurality of such electrode cells may be repeatedly disposed to form an electrode assembly 150. In some embodiments, the electrode assembly 150 may be a winding type, a stacking type, a z-folding type, or a stacked-folding type.

The electrode assembly 150 may be accommodated in a case 160 together with the above-described electrolyte to define the lithium secondary battery. For example, the above-described electrolyte may impregnate the electrode assembly 150.

As illustrated in FIG. 1, electrode tabs (cathode tabs and anode tabs) may be formed from the cathode current collector 105 and the anode current collector 125, each belonging to a respective electrode cell, and may extend to one side of the case 160. The electrode tabs may be welded together with the one side of the case 160 to form electrode leads (a cathode lead 107 and an anode lead 127) that extend from or are exposed to the outside of the case 160.

The lithium secondary battery may be manufactured, for example, in a cylindrical, prismatic, pouch, or coin type using a can.

Hereinafter, embodiments of the present disclosure will be further described with reference to specific experimental examples. However, the examples and comparative examples included in the experimental examples are provided merely for illustrative purposes of the present disclosure and those skilled in the art will obviously understand that various changes and modifications can be made within the scope and spirit of the present disclosure. Such changes and modifications are to be regarded as falling within the scope of the appended claims.

### Examples and Comparative Examples

### (1) Preparation of Anode Slurry

An anode slurry was prepared by adding and mixing (86.8-x) wt % of graphite and 10 wt % of silicon oxide (SiOₓ, 0<x<2) as anode active materials, 0.5 wt % of carbon nanotubes (CNTs) as a conductive material, 2.7 wt % of a binder, and x wt % of an organic acid compound in water. The binder and the organic acid compound were added in the types and/or contents (wt %) shown in Table 1 below.

The number of oxygen-containing functional groups (i.e., the number of functional groups) and the bond angle between the oxygen-containing functional groups in the organic acid compound are shown in Table 1. The bond angle between the oxygen-containing functional groups refers to the smallest internal angle formed by the bond lines of the oxygen-containing functional groups.

TABLE 1

| | | Organic acid compound | | | |
|---|---|---|---|---|---|
| | | | Number of | | |
| | Binder | | functional | Bond | Content (x |
| | Type | Type | groups | angle | wt %) |
| Example 1 | A1 | B1 | 2 | 180 | 0.04 |
| Example 2 | A1 | B2 | 2 | 180 | 0.04 |
| Example 3 | A1 | B3 | 2 | 109.5 | 0.02 |
| Example 4 | A1 | B3 | 2 | 109.5 | 0.04 |
| Example 5 | A1 | B3 | 2 | 109.5 | 0.08 |
| Example 6 | A2 | B3 | 2 | 109.5 | 0.04 |
| Example 7 | A3 | B3 | 2 | 109.5 | 0.04 |
| Example 8 | A1 | B4 | 2 | 109.5 | 0.04 |
| Example 9 | A1 | B3 | 2 | 109.5 | 0.015 |
| Example 10 | A1 | B3 | 2 | 109.5 | 0.09 |
| Example 11 | A1 | B3 | 2 | 109.5 | 0.04 |
| Example 12 | A4 | B3 | 2 | 109.5 | 0.04 |
| Example 13 | A5 | B3 | 2 | 109.5 | 0.04 |
| Comparative | A1 | — | — | — | — |
| Example 1 | | | | | |
| Comparative | A1 | B3 | 2 | 109.5 | 0.01 |
| Example 2 | | | | | |
| Comparative | A1 | B3 | 2 | 109.5 | 0.1 |
| Example 3 | | | | | |
| Comparative | A1 | B5 | 1 | — | 0.04 |
| Example 4 | | | | | |
| Comparative | A1 | B6 | 4 | 43.2 | 0.04 |
| Example 5 | | | | | |
| Comparative | A1 | B7 | 4 | 43.2 | 0.04 |
| Example 6 | | | | | |
| Comparative | A1 | B8 | 2 | 43.2 | 0.04 |
| Example 7 | | | | | |
| Comparative | A2 | — | — | — | — |
| Example 8 | | | | | |
| Comparative | A3 | — | — | — | — |
| Example 9 | | | | | |

The specific compounds listed in Table 1 are as follows:
A1: Sodium carboxymethyl cellulose (CMC) and SBR (CMC:SBR=1.2:1.5 weight ratio)
A2: PAA-PVA copolymer (PVA 40 wt %, PAA 60 wt %) and SBR (PAA-PVA:SBR=2.0:0.7 weight ratio)
A3: PAA-PAM copolymer (PAM 40 wt %, PAA 60 wt %) and SBR (PAA-PAM:SBR=2.0:0.7 weight ratio)
A4: PAA-PVA copolymer (PVA 40 wt %, PAA 60 wt %) and SBR (PAA-PVA:SBR=2.2:0.5 weight ratio)
A5: PAA-PAM copolymer (PAM 40 wt %, PAA 60 wt %) and SBR (PAA-PAM:SBR=2.2:0.5 weight ratio)
B1: Fumaric acid
B2: Oxalic acid
B3: Lactic acid
B4: Succinic acid
B5: Acetic acid
B6: Citric acid
B7: Tartaric acid
B8: Maleic acid

### (2) Manufacture of Lithium Secondary Battery

An anode active material layer was formed on an anode current collector using the anode slurry. Specifically, the anode slurry was uniformly coated on a copper foil (anode current collector) having a thickness of 8 μm, and then dried and roll-pressed to fabricate an anode.

A cathode slurry was prepared by mixing LiNi_{0.6}Co_{0.2}Mn_{0.2}O₂ as a cathode active material, carbon nanotubes (CNTs) as a conductive material, and PVdF as a binder in a weight ratio of 97.3:1.5:1.2. The cathode slurry was uniformly applied to an aluminum foil having a thickness of 10 μm, and then dried and roll-pressed to fabricate a cathode.

The cathode and anode were each cut to a predetermined size and stacked. A separator (polyethylene, thickness: 14 μm) was interposed between the cathode and anode to form an electrode assembly.

The electrode assembly was placed in an outer case, and an electrolyte was injected to manufacture a lithium secondary battery. A solution prepared by dissolving 1 M LiPF₆ and 5 wt % FEC additive in a mixed solvent of EC/EMC (30:70 v/v) was used as the electrolyte.

### Experimental Example

### (1) Measurement of pH of Anode Slurry

The pH of the anode slurry prepared according to the above-described examples and comparative examples was measured using a pH meter (CAS Benchtop pH tester PM-3).

### (2) Evaluation of Anode Adhesion

The adhesion between the anode current collector and the anode active material layer was measured using an adhesion measuring device (IMADA DS2-50N).

Specifically, double-sided tape was attached to an adhesion measurement jig, and the current collector side of the prepared anode was placed on the tape. A roller was reciprocated ten times to attach the anode. Subsequently, the tape was cut to a width of 18 mm and attached to a central portion of the measurement jig with the tape side facing downward. Thereafter, the adhesion to the anode active material layer was measured while the adhesion measuring device was moved at a speed of 300 mm/min.

### (3) Evaluation of Anode Swelling

A thickness (T₀) of the roll-pressed anode was measured. The lithium secondary battery manufactured using the anode was charged to a state of charge (SOC) of 100%. The battery was then disassembled, and a thickness (T₁) of the resulting anode was measured. The increased thickness (T₁-T₀) of the fully charged anode compared to the roll-pressed anode was converted into a percentage (%) of the roll-pressed anode's thickness (T₀) to evaluate swelling (%).

$$Swelling ( \% ) = ( ( {T}_{1} - {T}_{0} ) / {T}_{0} ) \times 100$$

### (4) Evaluation of Cycle Life Characteristics

The lithium secondary battery was charged (CC-CV 0.3C, 4.2 V, 0.05C cut-off) and discharged (CC 0.5C, 2.5 V cut-off) three times in a 25° C. chamber. The third discharge capacity was set as an initial discharge capacity. Thereafter, charging and discharging were defined as one cycle, and 500 cycles were performed, after which the discharge capacity at the 500th cycle was measured.

The initial discharge capacity was divided by the measured discharge capacity at the 500th cycle, and the result was converted to a percentage (%) to evaluate the cycle life characteristics.

### (5) Evaluation of High-Temperature Stability

The lithium secondary battery was charged (0.3C) to SOC 98% of the initial discharge capacity and then stored in a 60° C. oven for 20 weeks. Thereafter, the time required for the pouch to burst due to gas generated inside the lithium secondary battery was measured.

The evaluation results are shown in Table 2 below.

TABLE 2

| | | | | | High- |
|---|---|---|---|---|---|
| | | | | Cycle life | temperature |
| | Slurry | Adhesion | Swelling | characteristics | stability |
| | pH | (N/18 mm) | (%) | (%) | (weeks) |
| Example 1 | 7.2 | 0.56 | 30.0 | 90.9 | 27 |
| Example 2 | 7.2 | 0.55 | 29.9 | 90.7 | 27 |
| Example 3 | 7.2 | 0.56 | 30.8 | 89.9 | 28 |
| Example 4 | 7.2 | 0.56 | 30.2 | 90.5 | 28 |
| Example 5 | 7.1 | 0.51 | 30.1 | 90.6 | 27 |
| Example 6 | 7 | 0.51 | 27.8 | 93.3 | 27 |
| Example 7 | 7.1 | 0.46 | 29.4 | 90.3 | 26 |
| Example 8 | 7.2 | 0.55 | 30.4 | 90.1 | 27 |
| Example 9 | 7.4 | 0.55 | 31 | 87.2 | 28 |
| Example 10 | 7 | 0.46 | 30 | 85.9 | 27 |
| Example 11 | 7.1 | 0.55 | 31.1 | 80.8 | 27 |
| Example 12 | 7.2 | 0.55 | 30.9 | 84.8 | 25 |
| Example 13 | 7.2 | 0.42 | 29.2 | 84.3 | 25 |
| Comparative | 7.4 | 0.57 | 31.6 | 84.2 | 28 |
| Example 1 | | | | | |
| Comparative | 7.3 | 0.56 | 31.5 | 84.4 | 28 |
| Example 2 | | | | | |
| Comparative | 7.1 | 0.41 | 30.0 | 80.8 | 24 |
| Example 3 | | | | | |
| Comparative | 7.4 | 0.55 | 31.7 | 84.0 | 27 |
| Example 4 | | | | | |
| Comparative | 7.1 | 0.52 | 31.4 | 84.4 | 22 |
| Example 5 | | | | | |
| Comparative | 7.1 | 0.53 | 31.6 | 84.2 | 22 |
| Example 6 | | | | | |
| Comparative | 7.2 | 0.55 | 31.0 | 85.5 | 28 |
| Example 7 | | | | | |
| Comparative | 7.1 | 0.52 | 30.9 | 88.7 | 26 |
| Example 8 | | | | | |
| Comparative | 7.2 | 0.44 | 31.3 | 87.3 | 26 |
| Example 9 | | | | | |

Referring to Tables 1 and 2, the anodes for lithium secondary batteries manufactured using the anode slurries of the examples exhibited high adhesion and low swelling characteristics. In addition, the lithium secondary batteries of the examples exhibited high cycle life characteristics even under repeated charge and discharge cycles, and improved high-temperature stability.

However, in Comparative Examples 1, 8, and 9, in which the anode slurry did not contain an organic acid compound, swelling characteristics and cycle life characteristics of the anode were degraded. In Comparative Example 2, in which the organic acid compound was included in an amount of 0.01 wt % based on the total solid weight, the swelling characteristics and cycle life characteristics of the anode were degraded. In Comparative Example 3, in which the organic acid compound was included in an amount of 0.1 wt % based on the total solid weight, the anode active material layer exhibited low adhesion, and the cycle life characteristics and high-temperature stability were significantly degraded.

In Comparative Examples 4 to 7, the anode slurry included an organic acid compound having a single oxygen-containing functional group or a low bond angle, and adhesion, swelling characteristics, cycle life characteristics, and high-temperature stability were all degraded.

1. An aqueous anode slurry comprising:
an anode active material;
a binder; and
an organic acid compound having at least two oxygen-containing functional groups,
wherein in a molecular structure of the organic acid compound, a bond angle between the oxygen-containing functional groups is 90° or more, and
wherein the content of the organic acid compound is greater than 0.01% by weight and less than 0.1% by weight, based on the total solid weight of the aqueous anode slurry.

2. The aqueous anode slurry according to claim 1, wherein the binder comprises carboxymethyl cellulose, sodium carboxymethyl cellulose, lithium carboxymethyl cellulose, polyvinyl alcohol, polyacrylic acid, polyacrylamide, or a copolymer of two or more thereof.

3. The aqueous anode slurry according to claim 1, wherein the binder comprises polyvinyl alcohol, polyacrylic acid, polyacrylamide, or a copolymer of two or more thereof.

4. The aqueous anode slurry according to claim 1, wherein the anode active material comprises a silicon-containing material.

5. The aqueous anode slurry according to claim 1, wherein the oxygen-containing functional group comprises an aldehyde group, a carboxyl group, or a hydroxyl group bonded to a carbon atom that does not form a π bond with an oxygen atom.

6. The aqueous anode slurry according to claim 1, wherein in the molecular structure of the organic acid compound, the bond angle between the oxygen-containing functional groups is an internal angle between bond lines connecting the oxygen-containing functional groups and carbon atoms bonded thereto.

7. The aqueous anode slurry according to claim 1, wherein the organic acid compound comprises at least one acid compound selected from the group consisting of lactic acid, glycolic acid, succinic acid, fumaric acid, malonic acid, glutaric acid, adipic acid, pimelic acid, and oxalic acid.

8. The aqueous anode slurry according to claim 1, wherein the organic acid compound has two or three oxygen-containing functional groups.

9. The aqueous anode slurry according to claim 1, wherein the content of the organic acid compound is 0.02% by weight to 0.08% by weight, based on the total solid weight of the aqueous anode slurry.

10. The aqueous anode slurry according to claim 1, further comprising an aqueous solvent.

11. The aqueous anode slurry according to claim 1, wherein a pH of the aqueous anode slurry is 8 or less.

12. An anode for a lithium secondary battery comprising:
an anode active material layer comprising an anode active material, a binder, and an organic acid compound having at least two oxygen-containing functional groups,
wherein in a molecular structure of the organic acid compound, a bond angle between the oxygen-containing functional groups is 90° or more, and
wherein the content of the organic acid compound is greater than 0.01% by weight and less than 0.1% by weight, based on the total weight of the anode active material layer.

13. The anode for a lithium secondary battery according to claim 12, wherein the organic acid compound is crosslinked with the binder.

14. The anode for a lithium secondary battery according to claim 12, further comprising an anode current collector,
wherein the anode active material layer is disposed on at least one surface of the anode current collector.

15. The anode for a lithium secondary battery according to claim 14, wherein an adhesion between the anode active material layer and the anode current collector is 0.5 N/18 mm or more.

16. A lithium secondary battery comprising:
the anode for a lithium secondary battery according to claim 12; and
a cathode disposed opposite the anode for a lithium secondary battery.
